(19) United States
(12) Patent Application Publication
(10) Pub. No.: US 2008/0119177 A1
(43) Pub. Date: May 22, 2008

(54) Metadata Content Delivery System for Wireless Networks

(75) Inventors: Shant Hovnanian, New York, NY (US); Marcos R. Lara, New York, NY (US); Surjim Savjibhai Patel, Portland, OR (US); Sheldon Jackson Renan, Northridge, CA (US); George Jackson Renan, Portland, OR (US)

Correspondence Address: SYNNESTVEDT LECHNER & WOODBRIDGE LLP, P O BOX 592, 112 NASSAU STREET, PRINCETON, NJ, 08542-0592, US

(73) Assignee: SPEEDUS CORP., New York, NY (US)

(21) Appl. No.: 11/856,215

(22) Filed: Sep. 17, 2007

Related U.S. Application Data
(60) Provisional application No. 60/825,779, filed on Sep. 15, 2006.

(51) Int. Cl. H04M 3/42

(52) U.S. Cl. 455/414.2

(57) ABSTRACT

A system and method of delivering metadata content relevant to a wireless access point to a user of the wireless access point. A user accessing the network via a wireless access point may be initially directed to an interactive metadata page related to the wireless access point they are using. The metadata page may display location-based information provided by prior users of the access point and users may themselves provide site relevant metadata in the form of, for instance, comments, links, tagged objects or edits of existing metadata, or some combination thereof. The metadata page may also supply automatically, or semi-automatically, generated content such as maps based on the access points location, images based on tags supplied by users or relevant to structures or enterprises in the vicinity of the access point.

### CROSS REFERENCE TO RELATED APPLICATIONS

This application is related to, and claims priority from, U.S. Provisional Patent application No. 60/825,779 filed on Sep. 15, 2006, by Patel et al. entitled “Metadata Content Delivery System for Wireless Networks”, the contents of which are hereby incorporated by reference.

### FIELD OF THE INVENTION

The present invention relates to systems and methods for presenting data related to a wireless access point, and more particularly to systems and methods for presenting metadata related to a wireless access point to users accessing a network via the wireless access point.

### BACKGROUND OF THE INVENTION

Automatically providing information relevant to a particular geographic locale to an a network user when that user is physically in, or close, to the locale may be useful for a variety of reasons including, but not limited to, adverting, promotional activities, community awareness, local safety, local tourism and providing directions.

Networks that automatically deliver location based information and/or services require a means of knowing where the user is based. This either requires the user to have some Global Positioning Service or to do a triangulation based on a user's reception of signals from identifiable transmission towers whose geographical location is known, or to be accessing a network via a wireless access point that has a limited range of use.

Once a user is known to be in a locale, the network providing the location based information and/or services needs to present the locale based information to the user.

Captive portal technology offers a way to provide location based information to wireless users logging on to a wireless access point. Captive portal technology forces a user of a wireless access point to see a specific web page selected by the access point owner before being allowed to access other web pages.

Captive portals are used for security and to limit liability by forcing users of the access point to agree to terms and conditions of use. Captive portals are also becoming used for promotional purposes.

One drawback of captive portals is that the wireless access point must support the required level of functionality to implement captive portals. Most consumer grade wireless access points or routers do not support the required level of functionality.

Many consumer based, shared access networks include a multitude of different wireless routers that do not support captive portal type functionality.

What is desirable is a way of implementing captive portal like functionality in order to deliver location based metadata, without the need to “flash” the wireless routers, i.e., the need to reprogram their flash memory, a process that, if not done correctly converts a wireless router into a “brick”, i.e., a non-functioning piece of equipment.

### SUMMARY OF THE INVENTION

Briefly described, the invention provides a system and method of delivering metadata content relevant to a wireless access point to users of the wireless access point. The system and methods are particularly relevant to communities of users who share secure access to wireless access points belonging to community members.

In a preferred embodiment of the invention, members of a secure, shared network accessing the network via a wireless access point may be initially directed to an interactive metadata page displaying metadata related to the wireless access point they are using. The same level of security preventing access to the secure, shared access point protects the contents of the interactive metadata page from undesirable vandalism. The metadata page may display location-based information provided by prior users of the access point and may themselves provide site relevant metadata in the form of, for instance, comments, links, tagged objects or edits of existing metadata, or some combination thereof. The metadata page may also supply automatically, or semi-automatically, generated content such as, but not limited to, maps based on the access points location, images base on tags supplied by users or relevant to structures or enterprises in the vicinity of the access point.

These and other features of the invention will be more fully understood by references to the following drawings.

### BRIEF DESCRIPTION OF THE DRAWINGS

FIG. 1 is a schematic drawing of a wireless access point capable of implementing the metadata content delivery system of one embodiment of the present invention.

FIG. 2 is an interaction diagram showing steps relevant to implementing the metadata content delivery system of one embodiment of the present invention.

FIG. 2A is an interaction diagram showing steps relevant to implementing the metadata content delivery system of a further embodiment of the present invention.

FIG. 3 is a schematic diagram showing a web-browser displaying metadata content in accordance with one embodiment of the present invention.

### DETAILED DESCRIPTION

The present invention applies to systems and methods for displaying metadata relevant to a particular wireless access point to a user accessing a network via the particular wireless access point.

Metadata, loosely defined, is data about data. In the context of a wireless access point located at a specific geographic location, metadata may include, for instance, data relevant to the geographic location, including maps, data about local enterprises, local structures and people living or temporally located in the proximity of the access points geographical location, as well as the opinions, demographics or desires of users accessing the internet via the particular access points. Such metadata may take the form, for instance, of text, images, speech, music or some combination and may be preprogrammed, dynamically generated or entered interactively by users of the access point.

A preferred embodiment of the invention is directed to members of a secure, shared network accessing the network via a wireless access point. When they securely log onto a community access point, they may be initially directed to an interactive metadata page displaying metadata related to the wireless access point they are using. The same level of security preventing access to the secure, shared access point protects the contents of the interactive metadata page from undesirable vandalism. The metadata page may include access point based information provided by prior users of the access point and users may themselves provide site relevant metadata in the form of, for instance, comments, links, tagged objects or edits of existing metadata, or some combination thereof. The metadata page may also supply automatically, or semi-automatically, generated content such as, but not limited to, maps based on the access points location, images base on tags supplied by users or relevant to structures or enterprises in the vicinity of the access point, or provided by web cams located near the access point.

A preferred embodiment of the invention will now be described in detail by reference to the accompanying drawings in which, as far as possible, like elements are designated by like numbers.

Although every reasonable attempt is made in the accompanying drawings to represent the various elements of the embodiments in relative scale, it is not always possible to do so with the limitations of two-dimensional paper. Accordingly, in order to properly represent the relationships of various features among each other in the depicted embodiments and to properly demonstrate the invention in a reasonably simplified fashion, it is necessary at times to deviate from absolute scale in the attached drawings. However, one of ordinary skill in the art would fully appreciate and acknowledge any such scale deviations as not limiting the enablement of the disclosed embodiments.

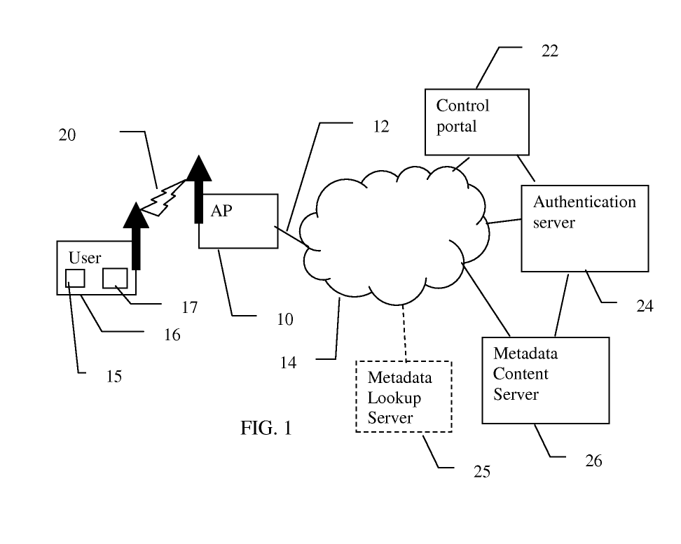

FIG. 1 is a schematic drawing of a wireless access point 10 capable of implementing the metadata content delivery system of one embodiment of the present invention.

The wireless access point 10 is connected to the network 14 by a data link 12 that may include, but is not limited to, a high speed cable modem and cable or fiber-optic land line connection. A user accessing the network 14 via the secured wireless access point 10 using a user's wireless computer 16 will need to have a community supplied client application 15 running on the user's wireless computer 16. The community supplied client application 15 knows, or is able to compute, the encryption keys of the wireless access point 10 based on, for instance, its MAC address. Once the community supplied client application 15 has made access to the wireless access point 10, it may act like a security fire wall, taking its instructions from the community control portal 22 and the associated authentication server 24. If access is granted to the user's wireless computer 16, the authentication server 24 or the community control portal 22 may also check a metadata content server 26 to see if there is an interactive metadata content page 58 associated with the wireless access point 10. If there is an interactive metadata content page 58 for the wireless access point 10 that will be served to the user's wireless computer 16 before the community supplied client application 15 pops up a web browser 17 and allows the user to serf to any other web sites. Such an implementation provides a functionality essentially equivalent to that of a captive portal, or a captive portal redirect, but does not require any specific captive portal or redirect functionality on the part of the wireless access point 10.

There may also be a metadata lookup server 25 that is optionally distinct from the other servers or the control portal 22.

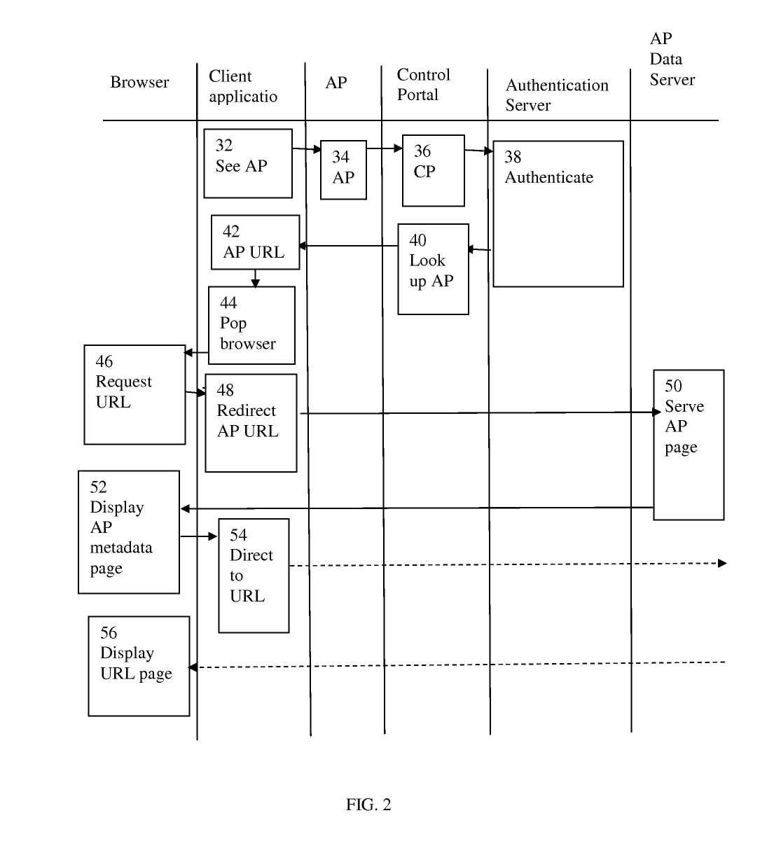

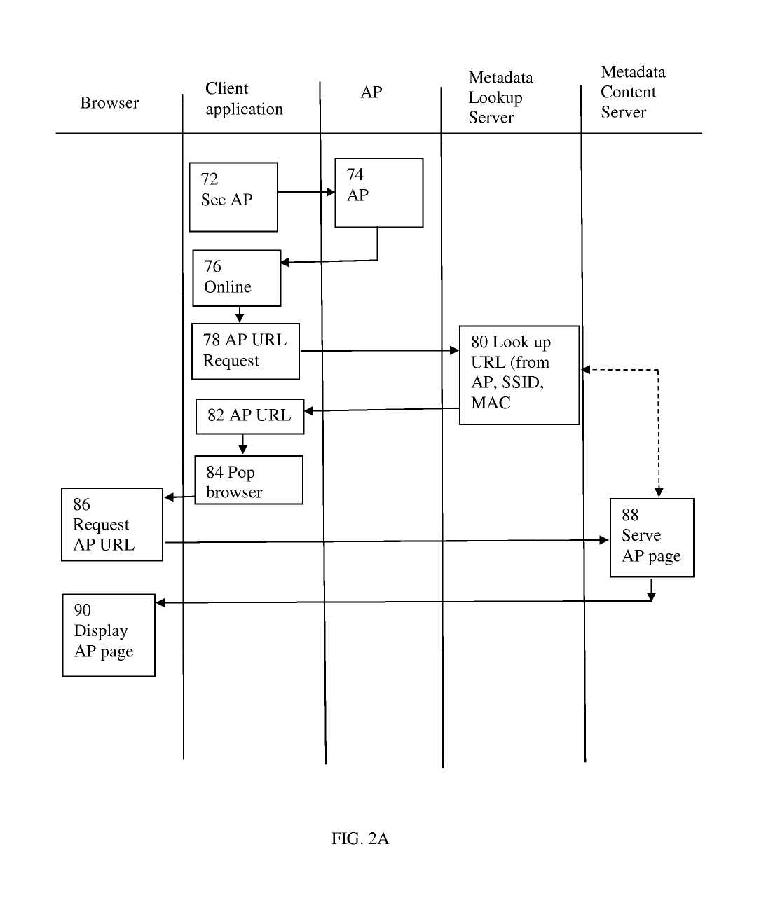

FIG. 2 is an interaction diagram showing steps relevant to implementing the metadata content delivery system of one embodiment of the present invention.

In step 32, the community supplied client application 15 running on the user's wireless computer 16 sees the wireless access point 10 and establishes contact with the wireless access point 10 in step 34. Using that contact, in step 36, the community supplied client application 15 accesses the community control portal 22 and then, in step 38, the authentication server 24 to authenticate the user's wireless computer 16 as a bone fide member of the community in good standing to be permitted to use the shared, community wireless access point 10. In step 40, the community control portal 22 looks up the wireless access point 10 in a database to see if there is an interactive metadata content page 58 associated with it. If there is an interactive metadata content page 58 associated with the wireless access point 10, a content identifier, that may be the universal resource locator (URL) of the interactive metadata content page 58, is supplied to the community supplied client application 15. In step 42, this AP URL is made available to a browser 17 that the authenticated community supplied client application 15 pops up in step 44. In step 46, the user 46, the user begins web surfing by inputting a requested URL to the web browser 17. In step 48, the community supplied client application 15 redirects the request to the AP URL, i.e., the URL of the interactive metadata content page 58.

In step 50, the metadata content server 26 servers up the interactive metadata content page 58. In step 52, the web browser 17 displays the interactive metadata content page 58 served up by the metadata content server 26.

In step 54, responsive to either a user selection on the interactive metadata content page 58 or to a timer running on the user's wireless computer 16, the community supplied client application 15 directs the web browser 17 to the URL requested by the user in step 46. In step 56, the web browser 17 displays the webpage requested by the user.

FIG. 2A is an interaction diagram showing steps relevant to implementing the metadata content delivery system of a further embodiment of the present invention.

In step 72, the community supplied client application 15 running on the user's wireless computer 16 sees the wireless access point 10 and establishes contact with the wireless access point 10 in step 74. In step 76, the community supplied client application 15 is now online. In step 78, the community supplied client application 15 requests the URL of the wireless access point 10 from the metadata lookup server 25 using the online link. In step 80, the metadata lookup server 25 looks up, or otherwise determines, the URL of the metadata HTML page associated with th wireless access point 10. This lookup, or determination, of the URL may, for instance, be based on the name of the access point, or the SSID or MAC of the access point or the machine hosting the access point, or some suitable combination thereof.

In step 82, the community supplied client application 15 receives the URL of the HTML page that is the home page of the web-site containing the metadata for the wireless access point 10. In step 84, the community supplied client application 15 pops up a web-browser 17. The web-browser 17 then requests the AP URL in step 86. In step 88, the metadata content server 26 serves the home page of the website associated with the wireless access point 10. In step 90, the home of the website associated with the wireless access point 10 is displayed by the web-browser 17.

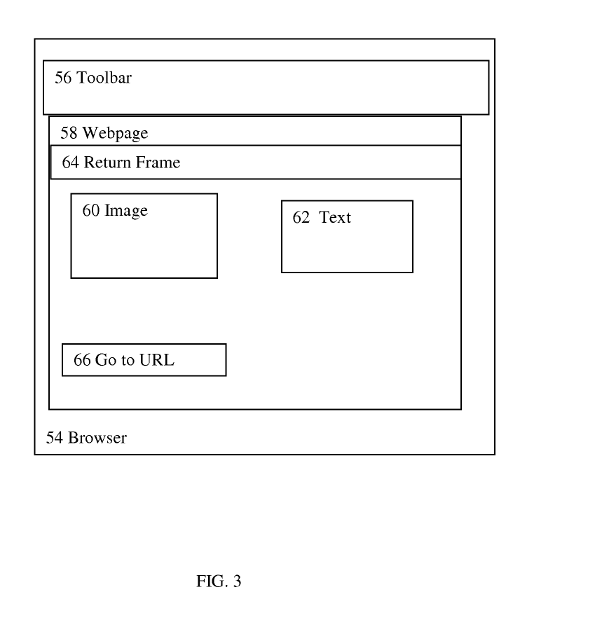

FIG. 3 is a schematic diagram showing a web-browser 54 displaying metadata content in accordance with one embodiment of the present invention. The web-browser 54 has a toolbar 56 and is displaying an interactive metadata content page 58.

The interactive metadata content page 58 includes a return frame 64 that will continue to be displayed even when the user is no longer looking at the interactive metadata content page 58. The return frame 64 allows the user to return to the interactive metadata content page 58 from any other page being displayed on the web-browser 54 during the session.

The interactive metadata content page 58 may include a display of images 60, a display of text 62 and a go to URL button 66. The go to URL button 66 allows the user to go from the interactive metadata content page 58 to the URL they originally requested.

The display of images 60 may, for instance, be automatically or semi-automatically loaded up from some other site such as, but not limited to, the Flickr™ site, based on one or more tags. Flickr™ is a trademark of Yahoo!, a Sunnvale, Calif. company that owns the Fliker™ website. The display of images 60 may also or instead include images or video streamed from one or more web cams associated with the location or one or more of the access point users.

The display of text 62 may include message posted by prior visitors to the interactive metadata content page 58 or they may be posted by email.

The structure of the interactive metadata content page 58 may be set up from a template by the first person to visit it. Subsequent visitors may then read, respond to, edit and otherwise interact with the interactive metadata content page 58 based on the structures and permissions allowed by the initial setup.

In a further embodiment of the invention, more than one wireless access point 10 may belong to or serve up the same interactive metadata content page 58.

In a further embodiment of the invention, access to one wireless access point 10 may display interactive metadata content page 58, or the URL to the interactive metadata content page 58, of one or more other wireless access point 10 in the vicinity.

The interactive metadata content page 58 may include features such as, but not limited to, a map-me feature in which the client may appear to flip over to show a map of the locale. The map of the locale may, for instance, be downloaded from Google maps or any other similar mapping facility.

In a further embodiment of the invention, the interactive metadata content page 58 may include a space for adding anonymous comments or for posting secrets. In a further embodiment of the invention, wireless access point 10 may further be capable of caching content for local users with the purpose of accelerating download times. Such a cache at the wireless access point 10 may be administered and managed locally or it may be administered and managed remotely by an Application Service Provider (ASP).

In a further embodiment, the wireless network gateway or wireless access point 10 may have a large built-in storage capacity such that the end-user can store data, either for personal use and/or to support other applications available to network users.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention. Modifications may readily be devised by those ordinarily skilled in the art without departing from the spirit or scope of the present invention.

What is claimed:

1. A method of receiving location based content, said method comprising the steps of:
providing a wireless communications device running a client application and a web browser;
providing a wireless access point;
establishing, by said client application, a wireless communications link between said wireless communications device and said wireless access point;
receiving from said wireless access point by said client application, a first content identifier associated with said wireless access point;
receiving, by said web browser, a second content identifier requested by a user of said wireless communications device;
substituting, by said client application, said second content identifier by said first content identifier;
accessing content associated with said first content identifier via said wireless access point; and
displaying, by said browser, said content associated with said first content identifier.

2. The method of claim 1 further comprising the steps of accessing, responsive to an input from said user, content associated with said second content identifier, and displaying, by said browser, said content associated with said second content identifier.

3. The method of claim 1 wherein said first content identifier is a uniform resource locator (URL) and wherein said content associated with said first content identifier comprises a Hyper Text Markup Language (HTML) page comprising one or more content elements relevant to said wireless access point.

4. The method of claim 3 wherein said content elements are further relevant to a location of said wireless access point.

5. The method of claim 3 wherein at least one of said content elements was placed on said HTML page by a prior user of said wireless access point.

6. The method of claim 1 wherein said step of receiving said first content identifier occurs subsequent to a user of said wireless device being authenticated as a member of a predetermined community of users.

7. A system for distributing location based content, comprising:
a wireless communications device running a client application and a web browser;
a wireless access point;
means for establishing, by said client application, a wireless communications link between said wireless communications device and said wireless access point;
means for receiving from said wireless access point by said client application, a first content identifier associated with said wireless access point;
means for receiving, by said web browser, a second content identifier requested by a user of said wireless communications device;
means for substituting, by said client application, said second content identifier by said first content identifier;
means for accessing content associated with said first content identifier via said wireless access point; and
means for displaying, by said browser, said content associated with said first content identifier.

8. The system of claim 7 further comprising means for accessing, responsive to an input from said user, content associated with said second content identifier, and means for displaying, by said browser, said content associated with said second content identifier.

9. The system of claim 7 wherein said first content identifier is a uniform resource locator (URL) and wherein said content associated with said first content identifier comprises a Hyper Text Markup Language (HTML) page comprising one or more content elements relevant to said wireless access point.

10. The system of claim 9 wherein said content elements are further relevant to a location of said wireless access point.

11. The system of claim 7 further comprising means for a user of said wireless device to place one or more content elements on said HTML page.

12. The system of claim 7 wherein receiving said first content identifier occurs subsequent to a user of said wireless device being authenticated as a member of a predetermined community of users.

13. An apparatus for distributing location based content, comprising:
a wireless communications device;
a wireless access point;
a web browser operative on said wireless communications device and capable of receiving a request for a first content identifier from a user of said wireless communications device;
a client application operative on said wireless communications device capable of establishing a wireless communications link between said wireless communications device and said wireless access point, of receiving from said wireless access point a second content identifier associated with said wireless access point, of substituting said second content identifier for said first content identifier; and
content associated with said second content identifier, capable of being accessed via said wireless access point and displayed by said browser.

14. The apparatus of claim 13 further comprising content associated with said first content identifier, capable of being accessed via said wireless access point and displayed by said browser subsequent to said display of said content associated with said second content identifier.

15. The apparatus of claim 13 wherein said second content identifier is a uniform resource locator (URL) and wherein said content associated with said second content identifier comprises a Hyper Text Markup Language (HTML) page comprising one or more content elements relevant to said wireless access point.

16. The apparatus of claim 15 wherein said content elements are further relevant to a location of said wireless access point.

17. The apparatus of claim 13 further comprising an HTML element enabling a user of said wireless device to place one or more content elements on said HTML page.
